(19) United States
(12) Patent Application Publication
(10) Pub. No.: US 2022/0409466 A1
(43) Pub. Date: Dec. 29, 2022

(54) KNEE MOVEMENT SUPPORT DEVICE

(71) Applicant: TOYOTA JIDOSHA KABUSHIKI KAISHA, Toyota-shi (JP)

(72) Inventor: Tomoe MAEKITA, Toyota-shi (JP)

(73) Assignee: TOYOTA JIDOSHA KABUSHIKI KAISHA, Toyota-shi (JP)

(21) Appl. No.: 17/702,341

(22) Filed: Mar. 23, 2022

(30) Foreign Application Priority Data
Jun. 24, 2021 (JP) 2021-104966

(51) Int. Cl. A61H 3/00

(52) U.S. Cl. CPC A61H 3/00; A61H 2003/007; A61H 2205/102

(57) ABSTRACT

A knee movement support device according to an embodiment of the present disclosure is a knee movement support device attached to a leg of a user, and includes: an upper leg link fastened to an upper leg of the user; a lower leg link fastened to a lower leg of the user; and an interval adjusting portion disposed between the upper leg of the user and the upper leg link or between the lower leg of the user and the lower leg link.

### CROSS-REFERENCE TO RELATED APPLICATION

This application claims priority to Japanese Patent Application No. 2021-104966 filed on Jun. 24, 2021, incorporated herein by reference in its entirety.

### BACKGROUND

### 1. Technical Field

The present disclosure relates to a knee movement support device, for example, a knee movement support device attached to a leg of the user.

### 2. Description of Related Art

For example, when a user such as a hemiplegic patient performs walking training, a knee movement support device is attached to an affected leg of a user in order to suppress early knee drop off of the affected leg. As disclosed in Japanese Unexamined Patent Application Publication No. 2018-114175 (JP 2018-114175 A), such a knee movement support device includes an upper leg link fastened to the upper leg of the affected leg of the user, a lower leg link that is connected to the upper leg link via a knee joint portion and fastened to the lower leg of the affected leg, and a motor unit that drives the knee joint portion. The knee movement device is configured to generate resistance to suppress early knee drop off of the affected leg of the user using a driving force of the motor unit.

### SUMMARY

The applicant has found the following issue. There are individual differences in the affected legs of the users. For example, the leg below the knee is a bow leg or the upper leg is thick. However, a general knee movement support device does not have a configuration that can correspond to the individual difference of the affected legs of the users.

Therefore, a knee joint axis of the affected leg of the user and a pivot axis of the upper leg link and the lower leg link of the knee movement support device cannot be arranged substantially in parallel to each other. Therefore, there may be a case where a large load is applied to the upper leg link or the lower leg link of the knee movement support device when the user walks.

The present disclosure has been made in view of the above issue, and realizes a knee movement support device capable of reducing the load applied to the upper leg link or the lower leg link when the user walks.

A knee movement support device according to an embodiment of the present disclosure is a knee movement support device attached to a leg of a user, and includes: an upper leg link fastened to an upper leg of the user; a lower leg link fastened to a lower leg of the user, and an interval adjusting portion disposed between the upper leg of the user and the upper leg link or between the lower leg of the user and the lower leg link.

The above-mentioned knee movement support device preferably further includes: a lower leg fastening portion that fastens the lower leg link to the lower leg of the user, and a height adjusting portion that is able to adjust a fastening height position of the lower leg fastening portion to the lower leg of the user.

In the above-mentioned knee movement support device, the interval adjusting portion is preferably a first spacer disposed between the lower leg fastening portion and the lower leg link via a bolt.

The above-mentioned knee movement support device preferably further includes an upper leg fastening portion that fastens the upper leg link to the upper leg of the user. The interval adjusting portion is preferably a second spacer disposed between the upper leg fastening portion and the upper leg link via a bolt.

The above-mentioned knee movement support device preferably includes a support belt that supports portions of the leg of the user above and below a knee.

According to the present disclosure, it is possible to realize a knee movement support device capable of reducing the load applied to the upper leg link or the lower leg link when the user walks.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a state in which a knee movement support device according to a first embodiment is attached to a leg of a user.

FIG. 2 is a view of a knee movement support device main body of the knee movement support device according to the first embodiment as viewed from the − side of a Y axis;

FIG. 3 is a sectional view showing a fastening structure between a cup of an upper leg fastening portion and an upper leg link of the knee movement support device according to the first embodiment; and

FIG. 4 is a diagram showing a knee movement support device according to a second embodiment.

### DETAILED DESCRIPTION OF EMBODIMENTS

Hereinafter, specific embodiments to which the present disclosure is applied will be described in detail with reference to the drawings. However, the present disclosure is not limited to the following embodiments. Further, in order to clarify the explanation, the following description and drawings have been simplified as appropriate.

### First Embodiment

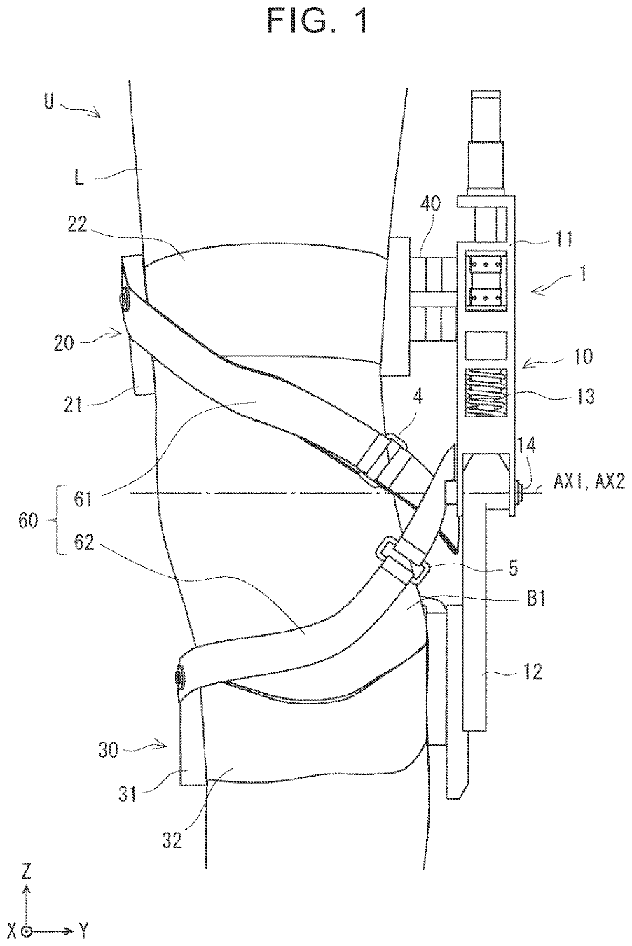

First, the configuration of a knee movement support device according to a first embodiment will be described. FIG. 1 is a diagram showing a state in which the knee movement support device according to the first embodiment is attached to a leg of a user. For example, as shown in FIG. 1, a knee movement support device 1 according to the present embodiment is attached to an affected leg L of a user U in order to suppress early knee drop off of the affected leg L when the user U such as a hemiplegic patient performs walking training.

Here, in the following description of the configuration of the knee movement support device 1, in order to clarify the explanation, the configuration of the knee movement support device 1 will be descried in the state shown in FIG. 1 or the like using the Cartesian coordinate system (XYZ coordinate system). At this time, the + side of the X axis is the front side of the knee movement support device 1, and the − side of the X axis is the rear side of the knee movement support device 1. The + side of the Y axis is the left side of the knee movement support device 1, and the − side of the Y axis is the rear side of the knee movement support device 1. The + side of the Z axis is the upper side of the knee movement support device 1, and the − side of the Z axis is the lower side of the knee movement support device 1.

In the first embodiment, the affected leg L of the user U is the left leg, and the knee movement support device 1 is configured to be attached to the left leg of which lower leg is the bow leg. However, although the knee movement support device 1 is configured to be attached to the left leg that is the affected leg L, when the knee movement support device 1 is attached to the right leg, the knee movement support device 1 is configured to be line-symmetrical with the Z axis as the axis of symmetry.

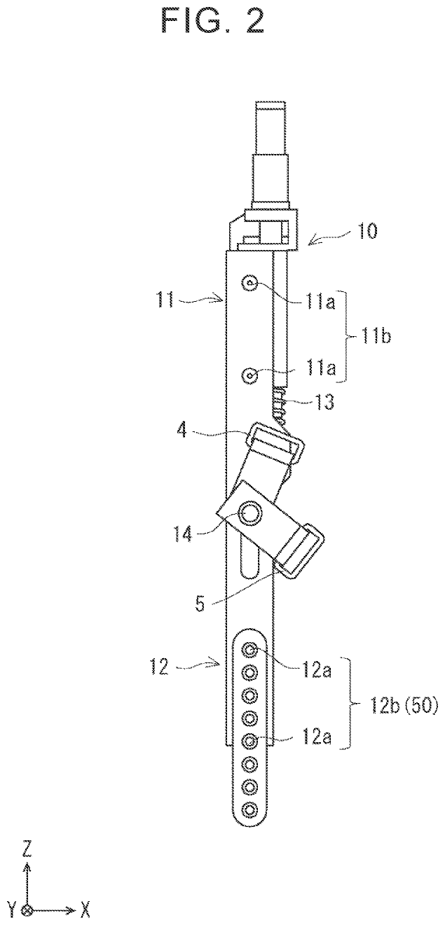

As shown in FIG. 1, the knee movement support device 1 includes a knee movement support device main body 10, an upper leg fastening portion 20, a lower leg fastening portion 30, an interval adjusting portion 40, and a height adjusting portion 50 (see FIG. 2), and a support belt 60.

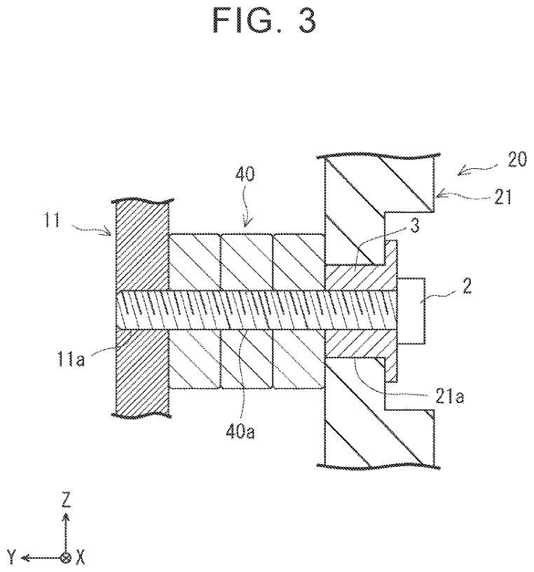

FIG. 2 is a view of the knee movement support device main body of the knee movement support device according to the first embodiment as viewed from the − side of the Y axis. FIG. 3 is a sectional view showing a fastening structure between a cup of the upper leg fastening portion and an upper leg link of the knee movement support device according to the first embodiment.

As shown in FIG. 2, the knee movement support device main body 10 includes an upper leg link 11, a lower leg link 12, and a resistance generating portion 13. Here, the upper leg link 11, the lower leg link 12, and the resistance generating portion 13 are preferably covered with a cover or the like such that the user U does not come into direct contact with the upper leg link 11, the lower leg link 12, and the resistance generating portion 13.

The upper leg link 11 and the lower leg link 12 have a longitudinal direction in the Z axis direction, for example, as shown in FIG. 2. Bolt holes 11a are provided on a surface of the upper leg link 11 on the − side of the Y axis at intervals in the Z axis direction. For example, the upper leg link 11 is provided with a bolt hole set 11b including two bolt holes 11a.

Bolt holes 12a are provided on a surface of the lower leg link 12 on the − side of the Y axis at intervals in the Z axis direction. Here, although the detailed function will be described later, the lower leg link 12 is preferably provided with a plurality of bolt hole sets 12b, each of which includes two bolt holes 12a.

An end portion of the upper leg link 11 on the − side of the Z axis and an end portion of the lower leg link 12 on the + side of the Z axis are connected via a joint shaft 14 extending in the Y axis direction.

For example, when the state of the affected leg L of the user U transitions from an idling leg state to a supporting leg state, the resistance generating portion 13 generates resistance so as to suppress early knee drop off of the affected leg L and restricts a relative rotation between the upper leg link 11 and the lower leg link 12.

However, a general knee movement support device main body can be used for the knee movement support device main body 10, and for example, a configuration in which a motor is used to generate resistance, or a damper is used to generate resistance can be adopted.

As shown in FIG. 1, the upper leg fastening portion 20 fastens the upper leg link 11 to the upper leg of the affected leg L of the user U. The upper leg fastening portion 20 includes, for example, a cup 21 and a cuff 22. The cup 21 has a substantially half-cylindrical shape, and opens on the + side of the X axis. That is, the cup 21 has a substantially U-shape when the cup 21 is viewed from the Z axis direction.

As shown in FIG. 3, through holes 21a penetrating the cup 21 in the Y axis direction are provided on a portion of the cup 21 on the + side of the Y axis at intervals in the Z axis direction, and a bolt 2 inserted through each of through holes 21a is screwed into the bolt hole 11a of the upper leg link 11 such that the cup 21 is fastened to the upper leg link 11.

At this time, the bolt 2 is inserted through the through hole 21a of the cup 21 via a collar 3. Further, a counterbore portion for accommodating the bolt head of the bolt 2 is preferably provided around the through hole 21a of the cup 21.

The cuff 22 is, for example, a belt and is fastened to the inner peripheral surface of the cup 21. One of a hook or a loop of a hook-and-loop fastener is provided around one end portion of the cuff 22, and the other of the hook or loop of the hook-and-loop fastener is provided around the other end portion of the cuff 22.

As shown in FIG. 1, the lower leg fastening portion 30 fastens the lower leg link 12 to the lower leg of the affected leg L of the user U. The lower leg fastening portion 30 includes, for example, a cup 31 and a cuff 32. The cup 31 has a substantially half-cylindrical shape, and opens on the + side of the X axis. That is, the cup 31 also has a substantially U-shape when the cup 31 is viewed from the Z axis direction.

Through holes penetrating the cup 31 in the Y axis direction are provided on a portion of the cup 31 on the + side of the Y axis at intervals in the Z axis direction, and a bolt inserted through each of through holes is screwed into the bolt hole 12a of the lower leg link 12 such that the cup 31 is fastened to the lower leg link 12.

At this time, the bolt is inserted through the through hole of the cup 31 via a collar. Further, a counterbore portion for accommodating the bolt head of the bolt is preferably provided around the through hole of the cup 31.

The cuff 32 is, for example, a belt and is fastened to the inner peripheral surface of the cup 31. One of a hook or a loop of a hook-and-loop fastener is provided around one end portion of the cuff 32, and the other of the hook or loop of the hook-and-loop fastener is provided around the other end portion of the cuff 32.

For example, as shown in FIG. 1, the interval adjusting portion 40 is disposed between the upper leg of the affected leg L of the user U and the upper leg link 11 such that a pivot axis AX1 of the upper leg link 11 and the lower leg link 12 (that is, a central axis extending through the center of the joint shaft 14) and a joint axis AX2 of the affected leg L of the user U are arranged substantially parallel to each other (that is, extending directions of the pivot axis AX1 of the upper leg link 11 and the lower leg link 12 and the joint axis AX2 of the affected leg L of the user U coincide with each other and the pivot axis AX1 of the upper leg link 11 and the lower leg link 12 and the joint axis AX2 of the affected leg L of the user U are arranged substantially parallel to each other).

Specifically, the interval adjusting portion 40 may be a spacer. That is, as shown in FIG. 3, the interval adjusting portion 40 is a plate having a predetermined thickness in the Y axis direction, and has a through hole 40a penetrating in the Y axis direction.

The interval adjusting portion 40 is fastened between the cup 21 of the upper leg fastening portion 20 and the upper leg link 11 by inserting the bolt 2 through the through hole 40a of the interval adjusting portion 40 in a state where the interval adjusting portion 40 is disposed between the cup 21 of the upper leg fastening portion 20 and the upper leg link 11.

As shown in FIG. 2, the height adjusting portion 50 is composed of the bolt hole sets 12b provided on the lower leg link 12. With this configuration, although detailed functions will be described later, the cup 31 of the lower leg fastening portion 30 is fastened to the bolt hole 12a consisting the desired bolt hole set 12b to allow adjustment of the fastening height position of the lower leg fastening portion 30 to the lower leg link 12 in the Z axis direction.

As shown in FIG. 1, the support belt 60 supports the knee of the affected leg L of the user U on the + side of the Z axis and on the − side of the Z axis. The support belt 60 includes a first belt 61 and a second belt 62. The first belt 61 may be made of, for example, an elastic member.

One end portion of the first belt 61 is fastened to a portion of an outer peripheral portion of the cup 21 of the upper leg fastening portion 20 on the − side of the Y axis. One of a hook or a loop of a hook-and-loop fastener is provided around the other end portion of the first belt 61.

For example, as shown in FIG. 1, the first belt 61 is folded back while being inserted through a first ring 4 fastened around the joint shaft 14 on the surface of the upper leg link 11 on the − side of the Y axis, and the one of the hook and the loop of the hook-and-loop fastener provided around the other end portion of the first belt 61 is joined to the other of the hook and the loop of the hook-and-loop fastener provided around one end portion of the first belt 61, whereby the first belt 61 is disposed diagonally to extend toward the + side of the Z axis as approaching the − side of the Y axis in the portion of the cup 21 of the upper leg fastening portion 20 on the + side of the X axis.

A second belt 62 may be made of, for example, an elastic member. One end portion of the second belt 62 is fastened to a portion of an outer peripheral portion of the cup 31 of the lower leg fastening portion 30 on the − side of the Y axis. One of a hook or a loop of a hook-and-loop fastener is provided around the other end portion of the second belt 62.

For example, as shown in FIG. 1, the second belt 62 is folded back while being inserted through a second ring 5 fastened around the joint shaft 14 on the surface of the upper leg link 11 on the − side of the Y axis, and the one of the hook and the loop of the hook-and-loop fastener provided around the other end portion of the second belt 62 is joined to the other of the hook and the loop of the hook-and-loop fastener provided around one end portion of the second belt 62, whereby the second belt 62 is disposed diagonally to extend toward the − side of the Z axis as approaching the − side of the Y axis in the portion of the cup 31 of the lower leg fastening portion 30 on the + side of the X axis.

Next, a flow of attaching the knee movement support device 1 according to the first embodiment to the affected leg L of the user U will be described. First, depending on the shape of the affected leg L of the user U, for example, an assistant who assists the walking training of the user U adjusts the number of the interval adjusting portions 40, or adjusts the fastening height position of the cup 31 of the lower leg fastening portion 30 to the lower leg link 12 using the height adjusting portion 50.

Specifically, when the knee movement support device 1 is attached to the affected leg L, the assistant places the desired number of the interval adjusting portions 40 between the upper leg link 11 and the cup 21 of the upper leg fastening portion 20 based on the condition of the bow leg under the knee of the affected leg L, a difference in thickness between the upper leg and the lower leg, and the like such that the pivot axis AX1 of the upper leg link 11 and the lower leg link 12 and the joint axis AX2 of the affected leg L are arranged substantially parallel to each other, and inserts the bolt 2 through the through hole 21a of the cup 21 of the upper leg fastening portion 20 and the through hole 40a of the interval adjusting portion 40 and screws the bolt 2 into the bolt hole 11a of the upper leg link 11. With this configuration, the upper leg fastening portion 20 can be fastened to the upper leg link 11 via the interval adjusting portion 40.

Then, when the knee movement support device 1 is attached to the affected leg L, the assistant selects a desired bolt hole set 12b from among the bolt hole sets 12b based on the position of a fibular head B1 of the affected leg L such that the lower leg fastening portion 30 does not come into contact with the fibular head B1 of the affected leg L, and inserts the bolt through the through hole of the cup 31 of the lower leg fastening portion 30 and screws the bolt into the bolt hole 12a consisting the selected bolt hole set 12b of the lower leg link 12. With this configuration, the lower leg fastening portion 30 can be fastened to the desired fastening height position of the lower leg link 12.

Next, the upper leg of the affected leg L of the user U is inserted through the cup 21 of the upper leg fastening portion 20, and the lower leg of the affected leg L is inserted through the cup 31 of the lower leg fastening portion 30. Then, the cuff 22 of the upper leg fastening portion 20 is wrapped around the upper leg of the affected leg L to join the hook-and-loop fastener, and the cuff 32 of the lower leg fastening portion 30 is wrapped around the lower leg of the affected leg L to join the hook-and-loop fastener. With this configuration, the upper leg fastening portion 20 can be fastened to the upper leg of the affected leg L, and the lower leg fastening portion 30 can be fastened to the lower leg of the affected leg L.

At this time, as shown in FIG. 1, the pivot axis AX1 of the upper leg link 11 and the lower leg link 12 and the joint axis AX2 of the affected leg L of the user U are preferentially arranged on substantially the same straight line. With this configuration, it is possible to reduce the discomfort when the user U performs walking training, and it is possible to reduce the load applied to the affected leg L.

Next, the first belt 61 is inserted through the first ring 4 and folded back to join the hook-and-loop fastener. With this configuration, the first belt 61 is disposed so as to diagonally cross over the portion of the affected leg L above the knee, and the first belt 61 can push the portion of the affected leg L above the knee toward the − side of the X axis.

Further, the second belt 62 is inserted through the second ring 5 and folded back to join the hook-and-loop fastener. With this configuration, the second belt 62 is disposed so as to diagonally cross over the portion of the affected leg L below the knee, and the second belt 62 can push the portion of the affected leg L below the knee toward the − side of the X axis.

When the knee movement support device 1 is attached to the affected leg L as described above, the knee movement support device 1 can support the affected leg L at three points, that is, the upper leg of the affected leg L by the upper leg fastening portion 20, the lower leg of the affected leg L by the lower leg fastening portion 30, and the knee of the affected leg L by the support belt 60. With this configuration, the knee movement support device 1 can be securely attached to the affected leg L.

At this time, as described above, since the interval adjusting portion 40 is disposed between the upper leg link 11 and the upper leg fastening portion 20, the pivot axis AX1 of the upper leg link 11 and the lower leg link 12 and the joint axis AX2 of the affected leg L can be arranged substantially in parallel to each other in the state in which the knee movement support device 1 is attached to the affected leg L.

With this configuration, when the user U performs walking training, the twist acting on the upper leg link 11 and the lower leg link 12 can be reduced, and the load applied to the upper leg link 11 and the lower leg link 12 can be reduced. Therefore, compared to a general knee movement support device, it is not necessary to construct the upper leg link 11 and the lower leg link 12 more rigidly, and the knee movement support device 1 can be made lighter and smaller.

Moreover, since the fastening height position of the lower leg fastening portion 30 to the lower leg link 12 is adjusted by the height adjusting portion 50, the contact with the fibular head B1 of the affected leg L of the lower leg fastening portion 30 can be suppressed in the state in which the knee movement support device 1 is attached to the affected leg L. With this configuration, when the user U performs walking training, the pressure ulcer of the affected leg L can be suppressed and the load applied to the affected leg L can be reduced.

As described above, the knee movement support device 1 according to the first embodiment includes the interval adjusting portion 40. Therefore, the pivot axis AX1 of the upper leg link 11 and the lower leg link 12 and the joint axis AX2 of the affected leg L can be arranged substantially parallel to each other in the state in which the knee movement support device 1 is attached to the affected leg L.

With this configuration, when the user U performs walking training, the twist acting on the upper leg link 11 and the lower leg link 12 can be reduced, and the load applied to the upper leg link 11 and the lower leg link 12 can be reduced. Therefore, compared to a general knee movement support device, it is not necessary to construct the upper leg link 11 and the lower leg link 12 more rigidly, and the knee movement support device 1 can be made lighter and smaller.

Moreover, the fastening height position of the lower leg fastening portion 30 to the lower leg link 12 can be adjusted by the height adjusting portion 50, whereby the contact between the fibular head B1 of the affected leg L and the lower leg fastening portion 30 can be suppressed in the state in which the knee movement support device 1 is attached to the affected leg L. With this configuration, when the user U performs walking training, the pressure ulcer of the affected leg L can be suppressed and the load applied to the affected leg L can be reduced.

Further, with the knee movement support device 1 according to the first embodiment, the interval between the upper leg link 11 and the upper leg fastening portion 20 can be adjusted and the fastening height position of the lower leg fastening portion 30 to the lower leg link 12 can be adjusted depending on the shape of the affected leg L of the user U as described above. Therefore, the knee movement support device 1 according to the first embodiment is excellent in versatility.

Further, when the interval adjusting portion 40 is composed of a spacer and the interval adjusting portion 40 is disposed between the upper leg link 11 and the upper leg fastening portion 20 via a bolt, the number of interval adjusting portions 40 can be easily changed.

### Second Embodiment

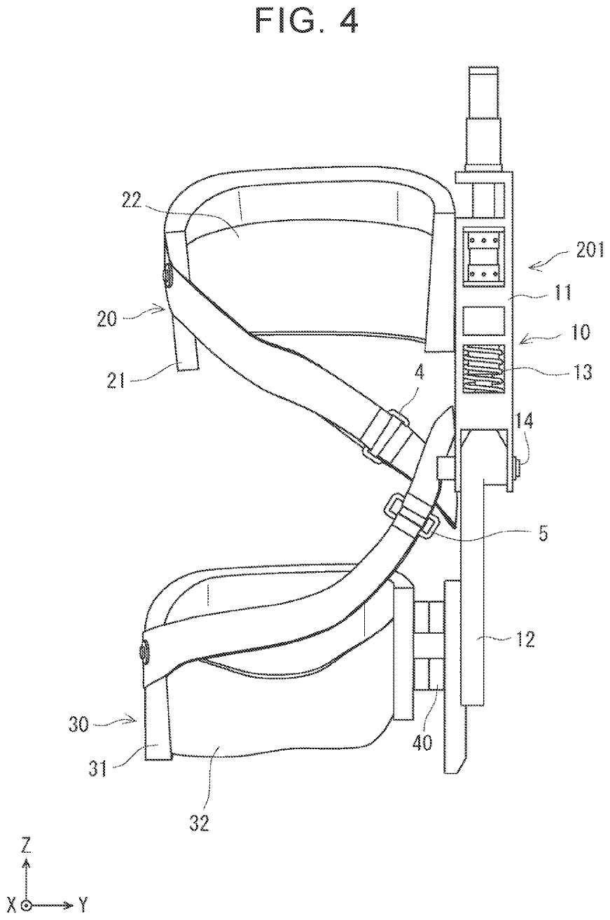

FIG. 4 is a diagram showing a knee movement support device according to a second embodiment. A knee movement support device 201 according to the second embodiment also has a configuration substantially the same as that of the knee movement support device 1 according to the first embodiment. However, the interval adjusting portion 40 is disposed between the lower leg link 12 and the lower leg fastening portion 30. With this configuration, the knee movement support device 201 according to the second embodiment can be configured to be attached to the affected leg of which upper leg is thick, for example.

The present disclosure is not limited to the above embodiments, and can be appropriately modified without departing from the spirit.

For example, in the knee movement support device according to the above embodiments, the interval adjusting portion 40 is disposed either between the upper leg link 11 and the upper leg fastening portion 20 or between the lower leg link 12 and the lower leg fastening portion 30. However, the interval adjusting portion 40 may be disposed between the upper leg link 11 and the upper leg fastening portion 20 and also disposed between the lower leg link 12 and the lower leg fastening portion 30.

For example, the interval adjusting portion 40 according to the above embodiments is composed of a spacer. However, the interval adjusting portion 40 only needs to be configured using a material that can adjust the interval between the upper leg link 11 and the upper leg of the affected leg, or between the lower leg link 12 and the lower leg of the affected leg, and may be configured of, for example, a urethane foam or the like.

For example, the upper leg fastening portion 20 according to the above embodiments includes the cup 21 and the cuff 22. However, the upper leg fastening portion 20 may have any configuration as long as the upper leg fastening portion 20 can fasten the upper leg link 11 to the upper leg of the affected leg. Similarly, although the lower leg fastening portion 30 also includes the cup 31 and the cuff 32, the lower leg fastening portion 30 may have any configuration as long as the lower leg fastening portion 30 can fasten the lower leg link 12 to the lower leg of the affected leg.

For example, the knee movement support device according the above embodiments includes the support belt 60. However, the support belt 60 may be omitted.

For example, the height adjusting portion 50 according to the above embodiments is composed of the bolt hole sets 12b. However, the height adjusting portion 50 may be configured of a slide rail or the like. In short, the height adjusting portion 50 may have any configuration as long as the fastening height position of the lower leg fastening portion 30 to the lower leg link 12 in the Z axis direction can be adjusted.

What is claimed is:

1. A knee movement support device that is attached to a leg of a user, the knee movement support device comprising:
an upper leg link fastened to an upper leg of the user;
a lower leg link fastened to a lower leg of the user; and
an interval adjusting portion disposed between the upper leg of the user and the upper leg link or between the lower leg of the user and the lower leg link.

2. The knee movement support device according to claim 1, further comprising:
a lower leg fastening portion that fastens the lower leg link to the lower leg of the user; and
a height adjusting portion that is able to adjust a fastening height position of the lower leg fastening portion to the lower leg of the user.

3. The knee movement support device according to claim 2, wherein the interval adjusting portion is a first spacer disposed between the lower leg fastening portion and the lower leg link via a bolt.

4. The knee movement support device according to claim 1, further comprising an upper leg fastening portion that fastens the upper leg link to the upper leg of the user, wherein the interval adjusting portion is a second spacer disposed between the upper leg fastening portion and the upper leg link via a bolt.

5. The knee movement support device according to claim 1, further comprising a support belt that supports portions of the leg of the user above and below a knee.
